(19) United States
(12) Patent Application Publication
(10) Pub. No.: US 2014/0049510 A1
(43) Pub. Date: Feb. 20, 2014

(54) CAPACITIVE TOUCH CONTROL SYSTEM

(71) Applicant: HANNSTAR DISPLAY CORP., New Taipei City (TW)

(72) Inventors: JUN-SHIH CHUNG, TAICHUNG CITY (TW); CHUN-HSI CHEN, PINGTUNG COUNTY (TW); CHIEN-HSIANG HUANG, TAINAN CITY (TW); KUN-HUA TSAI, TAINAN CITY (TW)

(73) Assignee: HANNSTAR DISPLAY CORP., New Taipei City (TW)

(21) Appl. No.: 13/895,520

(22) Filed: May 16, 2013

(30) Foreign Application Priority Data
Aug. 16, 2012 (CN) 201210292828.X

(51) Int. Cl. G06F 3/041; G06F 3/044

(52) U.S. Cl. CPC G06F 3/0416; G06F 3/044
USPC 345/174

(57) ABSTRACT

A capacitive touch control system includes a sensing matrix, a comparator and a control unit. The control unit is configured to couple the sensing matrix to at least one of two input terminals of the comparator, to provide at least one variable voltage to at least one of the two input terminals of the comparator and to adjust the at least one variable voltage according to a comparison result of the comparator so as to balance the two input terminals of the comparator to accordingly identify a touch event and a contact extent.

### CROSS REFERENCE TO RELATED APPLICATION

This application claims the priority benefit of Chinese Patent Application Number 201210292828.X, filed on Aug. 16, 2012, the full disclosure of which is incorporated herein by reference.

### BACKGROUND

1. Field of the Disclosure

This disclosure generally relates to an input device and, more particularly, to a capacitive touch control system capable of reducing the substrate area.

2. Description of the Related Art

As the touch control device is easy in operation and function expansion, it gradually replaces the traditional input devices, such as the mouse and the keyboard. And the capacitive touch control is the most popular technique.

Referring to FIG. 1, it shows a schematic diagram of the conventional capacitive touch control system, which includes a plurality of first electrodes 91 extending along a first axis and parallel to each other, and a plurality of second electrodes 92 extending along a second axis and parallel to each other. The driving signal S_{drive} is inputted from the first electrodes 91 and the detecting signal S_{detect} is outputted from the second electrodes 92. A processing unit is configured to identify a touch even and a touch position of a finger 8 according to a variation of the detecting signal S_{detect}.

In order to further expand the touch control function, besides the above touch event and touch position, a contact extent of the finger 8 is expected to be detected in some conditions. As shown in FIG. 1, the detecting signal S_{detect} is inputted into a comparator 93, and an input terminal 931 of the comparator is coupled to a capacitor bank 94, which is formed by a plurality of different capacitors. When a touch event occurs, different voltage values can appear on two input terminals of the comparator 93, and the voltage values can be balanced by changing the output capacitance of the capacitor bank 94 coupled to the input terminal 931. The contact extend of the finger 8 can be identified according to the capacitance variation of the capacitor bank 94. However, it is known that a large space is necessary in order to form the capacitor on a substrate. Furthermore, forming the capacitor bank 94 can significant increase the substrate area being occupied thereby increasing the substrate size and manufacturing cost.

Accordingly, the present disclosure further provides a capacitive touch control system capable of detecting a touch position and a contact extent, wherein capacitors having different capacitances need not be formed on the substrate so as to solve the problem in the conventional touch control system mentioned above.

### SUMMARY

The present disclosure provides a capacitive touch control system that provides at least one variable voltage for balancing the charge variation caused by a touch event and may identify a contact extend according to the adjusted value of the variable voltage.

The present disclosure provides a capacitive touch control system including a plurality of first sensing electrodes, a plurality of second sensing electrodes, a comparator and a control unit. The first sensing electrodes extend along a first direction in parallel. The second sensing electrodes extend along a second direction in parallel. The comparator has a positive input terminal and a negative input terminal. The control unit is configured to sequentially couple the first sensing electrodes to an input voltage source, to sequentially couple two of the second sensing electrodes to the positive input terminal and the negative input terminal of the comparator respectively, to provide a first variable voltage to the positive input terminal and to provide a second variable voltage to the negative input terminal thereby balancing the positive input terminal and the negative input terminal through adjusting the first variable voltage and/or the second variable voltage.

The present disclosure further provides a capacitive touch control system including a plurality of first sensing electrodes, a plurality of second sensing electrodes, a comparator and a control unit. The first sensing electrodes extend along a first direction in parallel. The second sensing electrodes extend along a second direction in parallel. The comparator has a first input terminal and a second input terminal, wherein the second input terminal is coupled to a reference voltage. The control unit is configured to sequentially couple two of the first sensing electrodes to a first input voltage source and a second input voltage source respectively, to sequentially couple the second sensing electrodes to the first input terminal of the comparator and to provide a variable voltage to the first input terminal of the comparator thereby balancing the first input terminal and the reference voltage through adjusting the variable voltage.

The present disclosure further provides a capacitive touch control system including a plurality of first sensing electrodes, a plurality of second sensing electrodes, a comparator and a control unit. The first sensing electrodes extend along a first direction in parallel. The second sensing electrodes extend along a second direction in parallel. The comparator has a first input terminal and a second input terminal, wherein the second input terminal is coupled to a reference voltage. The control unit is configured to sequentially couple the second sensing electrodes to the first input terminal of the comparator and to couple two of the first sensing electrodes to an input voltage source and a variable voltage respectively thereby balancing the first input terminal and the reference voltage through adjusting the variable voltage.

In one aspect, the first input terminal is a positive input terminal of the comparator and the second input terminal is a negative input terminal of the comparator; or the first input terminal is the negative input terminal and the second input terminal is the positive input terminal.

In one aspect, the control unit adjusts the variable voltage till a logic level of an output terminal of the comparator is changed, and this means that the positive input terminal and the negative input terminal of the comparator achieve the voltage balancing.

In one aspect, the capacitive touch control system further includes a plurality of input switch sets and a plurality of output switch sets, wherein the input switch sets are respectively coupled between the first sensing electrodes and the control unit, and the output switch sets are respectively coupled between the second sensing electrodes and at least one input terminal of the comparator.

In one aspect, the capacitive touch control system may include a reset stage. In the reset stage, the control unit is further configured to couple the first sensing electrodes and the second sensing electrodes to a reset voltage, wherein the reset stage may be between two scanning periods. The reset voltage may not be equal to voltage values of the input voltage source and the variable voltage.

In one aspect, the input voltage source, the reset voltage, the reference voltage and the variable voltage are all provided by the control unit.

In the touch control system according to the embodiment of the present disclosure, the control unit couples the sensing matrix to at least one of two input terminals of the comparator, provides at least one variable voltage to at least one of the two input terminals of the comparator and adjusts the variable voltage according to a comparison result of the comparator so as to balance voltage values on the two input terminals of the comparator to accordingly identify a touch event, a touch position and a contact extent. As a plurality of different capacitors are not formed on the substrate used as the means for balancing charges, the substrate area and manufacturing cost can be significantly reduced.

### BRIEF DESCRIPTION OF THE DRAWINGS

Other objects, advantages, and novel features of the present disclosure will become more apparent from the following detailed description when taken in conjunction with the accompanying drawings.

FIG. 1 shows a schematic diagram of the conventional capacitive touch control system.

FIG. 2 shows a schematic block diagram of the capacitive touch control system according to the embodiment of the present disclosure.

FIG. 3 shows a system structure of the capacitive touch control system according to a first embodiment of the present disclosure.

FIG. 4 shows a system structure of the capacitive touch control system according to a second embodiment of the present disclosure.

FIG. 5 shows a system structure of the capacitive touch control system according to a third embodiment of the present disclosure.

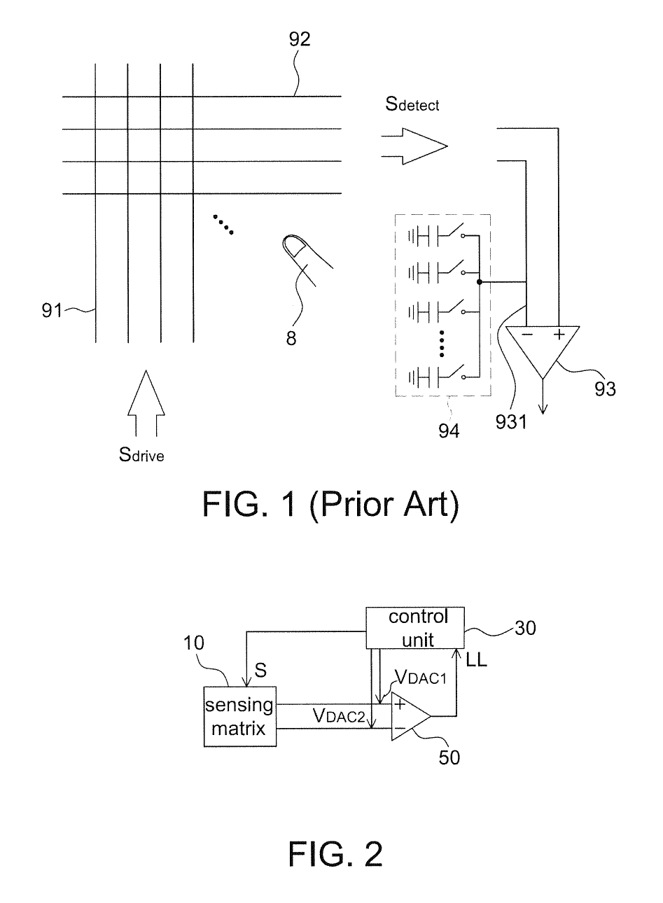

### DETAILED DESCRIPTION OF THE EMBODIMENT

It should be noted that, wherever possible, the same reference numbers will be used throughout the drawings to refer to the same or like parts.

Referring to FIG. 2, it shows a schematic block diagram of the touch control system according to an embodiment of the present disclosure, which includes a sensing matrix 10, a control unit 30 and a comparator 50. The sensing matrix 10 may be the conventional capacitive sensing matrix and include a plurality of first sensing electrodes extending along a first direction in parallel and a plurality of second sensing electrodes extending along a second direction in parallel, wherein the first direction is substantially perpendicular to the second direction. The method of forming a capacitive sensing matrix on a substrate is well known, for example, forming the first sensing electrodes and the second sensing electrodes interlacing with each other on the same side of a substrate or respectively forming the first sensing electrodes and the second sensing electrodes on two opposite sides of a substrate, and thus details thereof are not described herein.

The control unit 30 generates a control signal S to control the sensing matrix 10 to couple to at least one of two input terminals (e.g. a positive input terminal + and a negative input terminal −) of the comparator 50. For example, the control unit 30 may control a plurality of input switch sets so as to input a driving signal to the sensing matrix 10 and control a plurality of output switch sets so as to output a detecting signal to the comparator 50. When voltage values on the two input terminals of the comparator 50 are different, it means that a touch event occurs. The control unit 30 may identify a touch position according to the triggering of the input switch sets and the output switch sets when the touch event occurs.

The control unit 30 may further provide at least one variable voltage (e.g. V_{DAC1} and/or V_{DAC2} shown herein) to at least one of the two input terminals of the comparator 50, and may balance, by adjusting the at least one variable voltage, the voltage values on the two input terminals of the comparator 50 according to a comparison result of the comparator 50, and may identify a contact extent according to the adjusted value of the at least one variable voltage. For example, the control unit 30 may gradually change the at least one variable voltage, e.g. adjusting a voltage step each time, till a logic level LL on an output terminal of the comparator 50 is changed. When the variable voltage is only provided to one of the two input terminals of the comparator 50, the other input terminal that is not coupled to the variable voltage may be coupled to a reference voltage, and the control unit 30 may adjust the variable voltage so as to balance the variable voltage and the reference voltage.

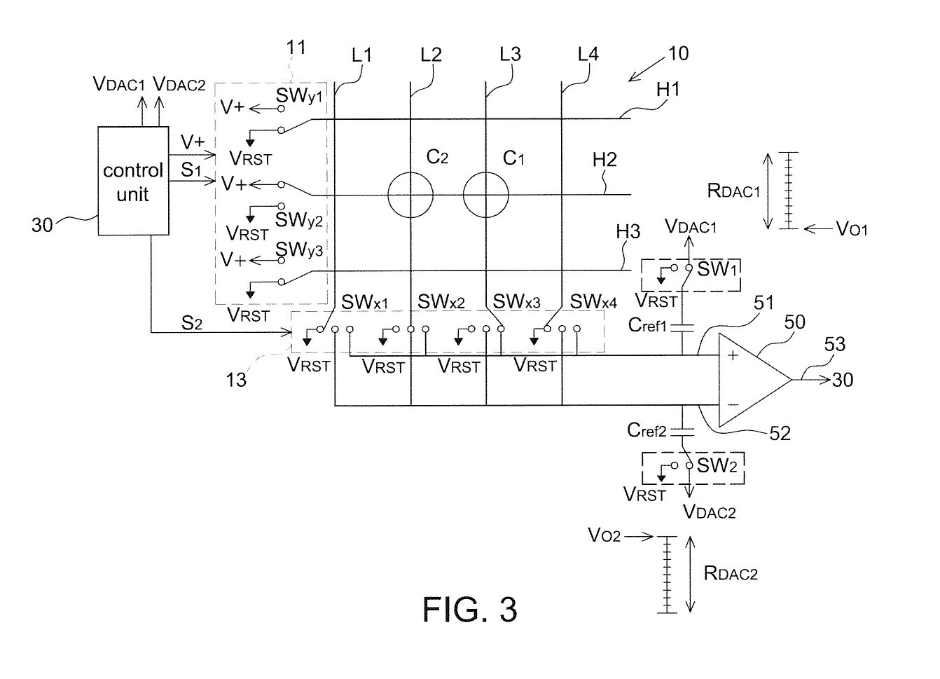

Referring to FIG. 3, it shows a system structure of the capacitive touch control system according to a first embodiment of the present disclosure, which includes a sensing matrix 10, a control unit 30 and a comparator 50, wherein the sensing matrix 10 includes a plurality of first sensing electrodes (e.g. three first sensing electrodes H1-H3 are shown herein), a plurality of second sensing electrodes (e.g. four second sensing electrodes L1-L4 are shown herein), a plurality of input switch sets 11 and a plurality of output switch sets 12.

The first sensing electrodes H1-H3 extend along a first direction in parallel, e.g. for detecting a Y-position of a touch event. The second sensing electrodes L1-L4 extend along a second direction in parallel, e.g. for detecting an X-position of the touch event. The input switch sets 11 are respectively coupled between the first sensing electrodes H1-H3 and the control unit 30; e.g. a first switch set SW_{y1} being coupled between a first sensing electrode H1 and the control unit 30, a first switch set SW_{y2} being coupled between a first sensing electrode H2 and the control unit 30, a first switch set SW_{y3} being coupled between a first sensing electrode H3 and the control unit 30 and so on. Accordingly, each of the first sensing electrodes H1-H3 may be coupled to an input voltage source V+ or a reset voltage V_{RST} through the input switch sets 11. In one embodiment, the input voltage source V+ and the reset voltage V_{RST} may both be provided by the control unit 30. The out switch sets 12 are respectively coupled between the second sensing electrodes L1-L4 and the comparator 50 or the reset voltage V_{RST}; e.g. a second switch set SWₓ₁ being coupled between a second sensing electrode L1 and the comparator 50 or the reset voltage V_{RST}, a second switch set SWₓ₂ being coupled between a second sensing electrode L2 and the comparator 50 or the reset voltage V_{RST}, a second switch set SWₓ₃ being coupled between a second sensing electrode L3 and the comparator 50 or the reset voltage V_{RST}, a second switch set SWₓ₄ being coupled between a second sensing electrode L4 and the comparator 50 or the reset voltage V_{RST} and so on. Accordingly, each of the second sensing electrodes L1-L4 may be coupled to one of the two input terminals of the comparator 50 or coupled to the reset voltage V_{RST} through the output switch sets 12.

The comparator 50 has a positive input terminal 51, a negative input terminal 52 and an output terminal 53, and the output terminal 53 may output a logic level “1” or “0” to the control unit 30, wherein when a voltage value on the positive input terminal 51 is higher than that on the negative input terminal 52, the output terminal 53 may output the logic level “1”, whereas when a voltage value on the positive input terminal 51 is lower than that on the negative input terminal 52, the output terminal 53 may output the logic level “0”.

The control unit 30 sequentially controls the first sensing electrodes H1-H3 to couple to the input voltage source V+, sequentially controls two of the second sensing electrodes L1-L4 to respectively couple to the positive input terminal 51 and the negative input terminal 52 of the comparator 50, provides a first variable voltage V_{DAC1} to the positive input terminal 51 and provides a second variable voltage V_{DAC2} to the negative input terminal 52 in order to balance voltage values on the positive input terminal 51 and the negative input terminal 52.

In FIG. 3, the control unit 30 sequentially (e.g. from H1 to H3) controls the input switch sets 11 to switch to the input voltage source V+ (e.g. the control unit 30 sending a first control signal S₁ to control the switching of the input switch sets 11). The control unit 30 also sequentially (e.g. from L1 to L4) controls two adjacent output switch sets 12 to respectively switch to the positive input terminal 51 and the negative input terminal 52 of the comparator 50 (e.g. the control unit 30 sending a second control signal S₂ to control the switching of the output switch sets 12). For example in the status shown in FIG. 3, the control unit 30 couples the first sensing electrode H2 to the input voltage source V+, couples the second sensing electrode L3 to the positive input terminal 51 and couples the second sensing electrode L2 to the negative input terminal 52. When an object (e.g. a finger or a touch pen) touches the contact point C1 or C2, the voltage balancing between the positive input terminal 51 and the negative input terminal 52 is destroyed such that the control unit 30 may identify the occurrence of a touch event.

For example, when the touch event occurs at the contact point C1, the voltage value on the positive input terminal 51 is lower than that on the negative input terminal 52 such that the output terminal 53 may output the logic level “0”; and the control unit 30 may increase the first variable voltage V_{DAC1} or decrease the second variable voltage V_{DAC2} till the logic level outputted by the output terminal 53 is changed to “1”. When the touch event occurs at the contact point C2, the voltage value on the positive input terminal 51 is higher than that on the negative input terminal 52 such that the output terminal 53 may output the logic level “1”; and the control unit 30 may decrease the first variable voltage V_{DAC1} or increase the second variable voltage V_{DAC2} till the logic level outputted by the output terminal 53 is changed to “0”.

In this embodiment, a sequence of adjusting the first variable voltage V_{DAC1} and the second variable voltage V_{DAC2} does not have any limitation. For example, it is able to adjust the first variable voltage V_{DAC1} at first till the voltage balancing is reached. If the voltage balancing can not be reached by only adjusting the first variable voltage V_{DAC1}, the second variable voltage V_{DAC2} is then adjusted. Or it is able to adjust the second variable voltage V_{DAC2} at first and then adjust the first variable voltage V_{DAC1}. Or it is able to alternatively adjust the first variable voltage V_{DAC1} and the second variable voltage V_{DAC2}. As long as the control unit 30 adjusts the first variable voltage V_{DAC1} and/or the second variable voltage V_{DAC2} till the logic level of the output terminal 53 of the comparator 50 is changed, the positive input terminal 51 and the negative input terminal 52 reaches the voltage balancing. The control unit 30 may identify a contact extent according to the adjusted value of the first variable voltage V_{DAC1} and/or the adjusted value of the second variable voltage V_{DAC2}.

In addition, in order to prevent the identification result from being affected by the residual charge in the capacitance of circuit, the control unit 30 may couple the first sensing electrodes H1-H3 and the second sensing electrodes L1-L4 to the reset voltage V_{RST} in a reset stage so as to release the residual charge in the capacitance of circuit, wherein the reset voltage V_{RST} may be a fixed positive value, a fixed negative value or 0 as long as the reset voltage V_{RST} is not equal to a voltage value of the input voltage source V+. In the embodiment of the present disclosure, the reset stage may be between two scanning periods, and one scanning period is a time interval that the control unit 30 sequentially conducts all of the input switch sets 11 associated with the first sensing electrodes and all of the output switch sets 12 associated with the second sensing electrodes.

In one embodiment, the first variable voltage V_{DAC1} may have a first adjustable range R_{DAC1} and the second variable voltage V_{DAC2} may have a second adjustable range R_{DAC2}. In the reset stage, the first variable voltage V_{DAC1} may be reset to a minimum voltage V_{O1} of the first adjustable range R_{DAC1}, and the second variable voltage V_{DAC2} may be reset to a maximum voltage V_{O2} of the second adjustable range R_{DAC2}. Accordingly, the first variable voltage V_{DAC1} can only be increased and the second variable voltage V_{DAC2} can only be decreased so as to simplify the adjustment complexity, but the present disclosure is not limited thereto. That is, in the reset stage the first variable voltage V_{DAC1} may be reset to any value within the first adjustable range R_{DAC1} and the second variable voltage V_{DAC2} may be reset to any value within the second adjustable range R_{DAC2}.

The capacitive touch control system of the present embodiment may further include a first switch set SW1 and a first capacitor C_{ref1} cascaded in series and further include a second switch set SW2 and a second capacitor C_{ref2} cascaded in series, wherein the cascaded first switch set SW1 and first capacitor C_{ref1} are coupled between the first variable voltage V_{DAC1} (i.e. the control unit 30) and the positive input terminal 51, and the cascaded second switch set SW2 and second capacitor C_{ref2} are coupled between the second variable voltage V_{DAC2} (i.e. the control unit 30) and the negative input terminal 52. The control unit 30 may also couple the first capacitor C_{ref1} and the second capacitor C_{ref2} to the reset voltage V_{RST} in the reset stage so as to release the residual charge therein.

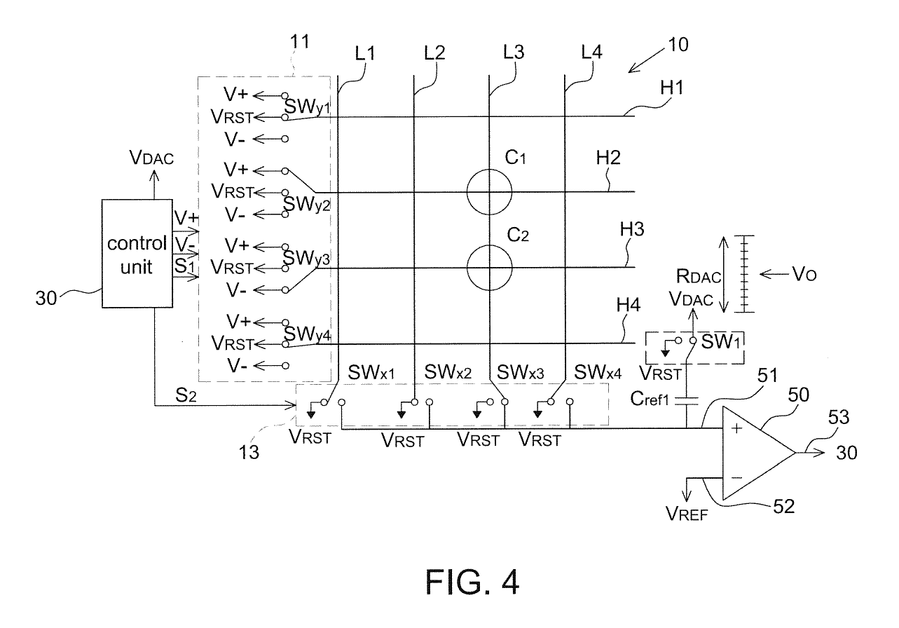

Referring to FIG. 4, it shows a system structure of the capacitive touch control system according to a second embodiment of the present disclosure, which includes a sensing matrix 10, a control unit 30 and a comparator 50, wherein the sensing matrix 10 includes a plurality of first sensing electrodes (e.g. four first sensing electrodes H1-H4 are shown herein), a plurality of second sensing electrodes (e.g. L1-L4), a plurality of input switch sets 11 and a plurality of output switch sets 12.

The first sensing electrodes H1-H4 extend along a first direction in parallel, e.g. for detecting a Y-position of a touch event; and the second sensing electrodes L1-L4 extend along a second direction in parallel, e.g. for detecting an X-position of the touch event. The input switch sets 11 are respectively coupled between the first sensing electrodes H1-H4 and the control unit 30; for example, a first switch set SW_{y1} being coupled between a first sensing electrode H1 and the control unit 30, a first switch set SW_{y2} being coupled between a first sensing electrode H2 and the control unit 30, a first switch set SW_{y3} being coupled between a first sensing electrode H3 and the control unit 30, a first switch set SW_{y4} being coupled between a first sensing electrode H4 and the control unit 30 and so on. Accordingly, each of the first sensing electrodes H1-H4 may be coupled to a first input voltage source V+, a second input voltage source V− or a reset voltage V_{RST} trough the input switch sets 11. In one embodiment, the first input voltage source V+, the second input voltage source V− and the reset voltage V_{RST} may all be provided by the control unit 30. The output switch sets 12 are respectively coupled between the second sensing electrodes L1-L4 and one of two input terminals of the comparator 50 or the reset voltage V_{RST}; for example, a second switch set SWₓ₁ being coupled between a second sensing electrode L1 and a positive input terminal 51 of the comparator 50 or the reset voltage V_{RST}, a second switch set SWₓ₂ being coupled between a second sensing electrode L2 and the positive input terminal 51 of the comparator 50 or the reset voltage V_{RST}, a second switch set SWₓ₃ being coupled between a second sensing electrode L3 and the positive input terminal 51 of the comparator 50 or the reset voltage V_{RST}, a second switch set SWₓ₄ being coupled between a second sensing electrode L4 and the positive input terminal 51 of the comparator 50 or the reset voltage V_{RST} and so on. Accordingly, each of the second sensing electrodes L1-L4 may be coupled to one of the two input terminals of the comparator 50 or the reset voltage V_{RST} through the output switch sets 12.

The comparator 50 has a positive input terminal 51, a negative input terminal 52 and an output terminal 53, and the output terminal 53 may output a logic level “1” or “0” to the control unit 30. In this embodiment, the positive input terminal 51 is coupled to the second sensing electrodes L1-L4 through the output switch sets 13 and the negative input terminal 52 is coupled to a reference voltage V_{REF}. In another embodiment, the positive input terminal 51 may be coupled to the reference voltage V_{REF} and the negative input terminal 52 may be coupled to the second sensing electrodes L1-L4 through the output switch sets 13.

The control unit 30 sequentially controls two of the first sensing electrodes H1-H4 to respectively couple to the first input voltage source V+ and the second input voltage source −, sequentially controls the second sensing electrodes L1-L4 to couple to the positive input terminal 51 of the comparator 50 (assuming the negative input terminal 52 being coupled to the reference voltage V_{REF}), and provides a variable voltage V_{DAC} to the positive input terminal 51 so as to balance voltage values on the positive input terminal 51 and the negative input terminal 52, wherein a voltage value on the first input voltage source V+ is not equal to that on the second input voltage source V−.

In FIG. 4, the control unit 30 sequentially (e.g. from H1 to H4) controls two adjacent input switch sets 11 to respectively switch to (i.e. conduct) the first input voltage source V+ and the second input voltage source V− (e.g. the control unit 30 sending a first control signal S₁ to control the switching of the input switch sets 11). The control unit 30 also sequentially (e.g. from L1 to L4) controls the output switch sets 12 to switch to (i.e. conduct) the positive input terminal 51 of the comparator 50 (e.g. the control unit 30 sending a second control signal S₂ to control the switching of the output switch sets 12). For example in the status shown in FIG. 4, the control unit 30 couples the first sensing electrode H2 to the first input voltage source V+, couples the first sensing electrode H3 to the second input voltage source V− and couples the second sensing electrode L3 to the positive input terminal 51. When an object touches the contact point C1 or C2, the voltage balancing between the positive input terminal 51 and the negative input terminal 52 is destroyed such that the control unit 30 may identify the occurrence of a touch event.

For example, when the touch event occurs at the contact point C1, the voltage value on the positive input terminal 51 is lower than that on the negative input terminal 52 such that the output terminal 53 may output the logic level “0”; and the control unit 30 may increase the variable voltage V_{DAC} till the logic level outputted by the output terminal 53 is changed to “1”. When the touch event occurs at the contact point C2, the voltage value on the positive input terminal 51 is higher than that on the negative input terminal 52 such that the output terminal 53 may output the logic level “1”; and the control unit 30 may decrease the variable voltage V_{DAC} till the logic level outputted by the output terminal 53 is changed to “0”. In this embodiment, the control unit 30 adjusts the variable voltage V_{DAC} till the logic level outputted by the output terminal 53 of the comparator 50 is changed, and this means that the positive input terminal 51 and the negative input terminal 52 reach the voltage balancing. The control unit 30 may identify a contact extend according to the adjusted value of the variable voltage V_{DAC}.

In addition, in order to prevent the identification result from being affected by the residual charge in the capacitance of circuit, the control unit 30 may couple the first sensing electrodes H1-H4 and the second sensing electrodes L1-L4 to the reset voltage V_{RST} in a reset stage so as to release the residual charge in the capacitance of circuit, wherein the reset voltage V_{RST} may be a fixed positive value, a fixed negative value or 0 as long as the reset voltage V_{RST} is not equal to voltage values of the first input voltage source V+ and the second input voltage source V−. Preferably, the reset voltage V_{RST} is between a voltage value of the first input voltage source V+ and a voltage value of the second input voltage source V−.

In one embodiment, the variable voltage V_{DAC} may have an adjustable range R_{DAC} and in the reset stage the variable voltage V_{DAC} may be reset to a middle voltage V_{O} of the adjustable range R_{DAC}. Accordingly, the variable voltage V_{DAC} may be increased or decreased to avoid the condition that the variable voltage V_{DAC} can not be adjusted, but the present disclosure is not limited thereto; that is, in the reset stage the variable voltage V_{DAC} may be reset to any value within the adjustable range R_{DAC}, and preferable the variable voltage V_{DAC} is not reset to the limit value of the adjustable range R_{DAC}.

The capacitive touch control system of this embodiment may further include a switch set SW1 and a capacitor C_{ref1} cascaded in series, wherein the cascaded switch set SW1 and capacitor C_{ref1} are coupled between the variable voltage V_{DAC} (i.e. the control unit 30) and the positive input terminal 51. The control unit 30 may also couple the capacitor C_{ref1} to the reset voltage V_{RST} in the reset stage so as to release the residual charge therein. In other embodiments, when the positive input terminal 51 of the comparator 50 is coupled to the reference voltage V_{REF}, the cascaded switch set SW1 and capacitor C_{ref1} are coupled between the variable voltage V_{DAC} and the negative input terminal 52. In this embodiment, the reset voltage V_{RST} is preferable equal to the reference voltage V_{REF}.

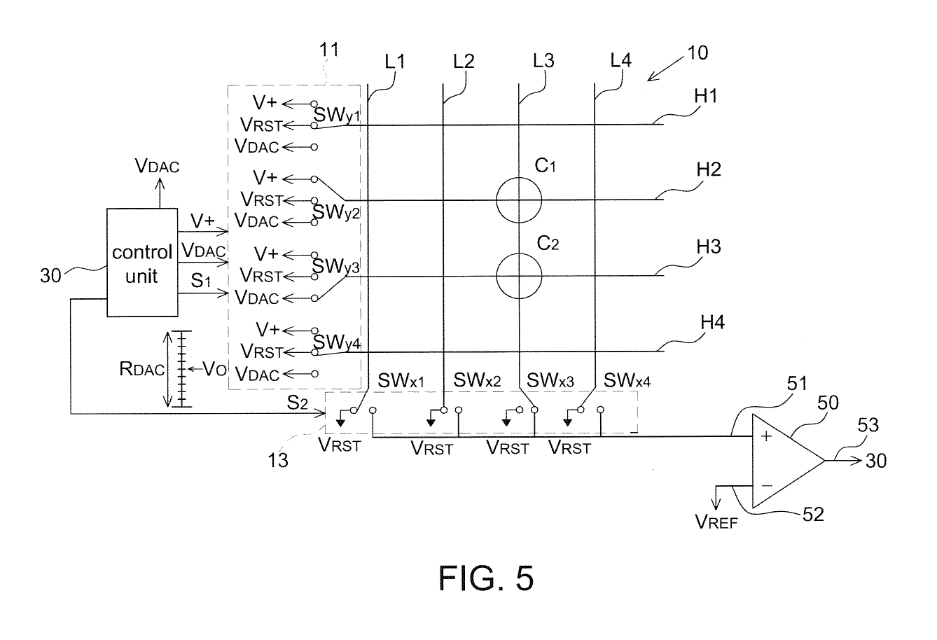

Referring to FIG. 5, it shows a system structure of the capacitive touch control system according to a third embodiment of the present disclosure, which includes a sensing matrix 10, a control unit 30 and a comparator 50, wherein the sensing matrix 10 includes a plurality of first sensing electrodes (e.g. H1-H4 are shown herein), a plurality of second sensing electrodes (e.g. L1-L4), a plurality of input switch sets 11 and a plurality of output switch sets 12.

The first sensing electrodes H1-H4 extend along a first direction in parallel, e.g. configured to detect a Y-position of a touch event; and the second sensing electrodes L1-L4 extend along a second direction in parallel, e.g. configured to detect an X-position of the touch event. The input switch sets 11 are respectively coupled between the first sensing electrodes H1-H4 and the control unit 30; the connection therebetween is similar to FIG. 4 and thus details thereof are not repeated herein. Accordingly, each of the first sensing electrodes H1-H4 may be coupled to an input voltage source V+, a variable voltage V_{DAC} or a reset voltage V_{RST} trough the input switch sets 11. In one embodiment, the input voltage source V+, the variable voltage V_{DAC} and the reset voltage V_{RST} may all be provided by the control unit 30. The output switch sets 12 are respectively coupled between the second sensing electrodes L1-L4 and one of two input terminals (e.g. the positive input terminal herein) of the comparator 50 or the reset voltage V_{RST}; the connection therebetween is similar to FIG. 4 and thus details thereof are not repeated herein. Accordingly, each of the second sensing electrodes L1-L4 may be coupled to one of the two input terminals of the comparator 50 or the reset voltage V_{RST} through the output switch sets 12.

The comparator 50 has a positive input terminal 51, a negative input terminal 52 and an output terminal 53, and the output terminal 53 may output a logic level “1” or “0” to the control unit 30. In this embodiment, the positive input terminal 51 is coupled to the second sensing electrodes L1-L4 through the output switch sets 13 and the negative input terminal 52 is coupled to the reference voltage V_{REF}. In another embodiment, the positive input terminal 51 may be coupled to the reference voltage V_{REF} and the negative input terminal 52 may be coupled to the second sensing electrodes L1-L4 through the output switch sets 13.

The control unit 30 sequentially controls the second sensing electrodes L1-L4 to couple to the positive input terminal 51 of the comparator 50 (assuming the negative input terminal 52 being coupled to the reference voltage V_{REF}), and sequentially controls two of the first sensing electrodes H1-H4 to respectively couple to the input voltage source V+ and the variable voltage V_{DAC} so as to balance voltage values on the positive input terminal 51 and the negative input terminal 52.

In FIG. 5, the control unit 30 sequentially (e.g. from H1 to H4) controls two adjacent input switch sets 11 to respectively switch to the input voltage source V+ and the variable voltage V_{DAC} (e.g. the control unit 30 sending a first control signal S₁ to control the switching of the input switch sets 11). The control unit 30 also sequentially (e.g. from L1 to L4) controls the output switch sets 12 to switch to the positive input terminal 51 of the comparator 50 (e.g. the control unit 30 sending a second control signal S₂ to control the switching of the output switch sets 12). For example in the status shown in FIG. 5, the control unit 30 couples the first sensing electrode H2 to the input voltage source V+, couples the first sensing electrode H3 to the variable voltage V_{DAC} and couples the second sensing electrode L3 to the positive input terminal 51. When an object touches the contact point C1 or C2, the voltage balancing between the positive input terminal 51 and the negative input terminal 52 is destroyed such that the control unit 30 may identify the occurrence of a touch event.

For example, when the touch event occurs at the contact point C1, the voltage value on the positive input terminal 51 is lower than that on the negative input terminal 52 such that the output terminal 53 may output the logic level “0”; and the control unit 30 may adjust the variable voltage V_{DAC} till the logic level outputted by the output terminal 53 is changed to “1”. When the touch event occurs at the contact point C2, the voltage value on the positive input terminal 51 is higher than that on the negative input terminal 52 such that the output terminal 53 may output the logic level “1”; and the control unit 30 may adjust the variable voltage V_{DAC} till the logic level outputted by the output terminal 53 is changed to “0”, wherein whether the variable voltage V_{DAC} is increased or decreased may be determined according to positive or negative values of the variable voltage V_{DAC}. In this embodiment, the control unit 30 adjusts the variable voltage V_{DAC} till the logic level outputted by the output terminal 53 of the comparator 50 is changed, and this means that the positive input terminal 51 and the negative input terminal 52 reach the voltage balancing. The control unit 30 may identify a contact extend according to the adjusted value of the variable voltage V_{DAC}.

In addition, in order to prevent the identification result from being affected by the residual charge in the capacitance of circuit, the control unit 30 may couple the first sensing electrodes H1-H4 and the second sensing electrodes L1-L4 to the reset voltage V_{RST} in a reset stage so as to release the residual charge in the capacitance of circuit, wherein the reset voltage V_{RST} may be a fixed positive value, a fixed negative value or 0 as long as the reset voltage V_{RST} is not equal to voltage values of the input voltage source V+ and the variable voltage V_{DAC}. Preferably, the reset voltage V_{RST} is between a voltage value of the input voltage source V+ and a voltage value of the variable voltage V_{DAC}.

In one embodiment, the variable voltage V_{DAC} has an adjustable range R_{DAC} and in the reset stage the variable voltage V_{DAC} may be reset to a middle voltage V_{O} of the adjustable range R_{DAC}. Accordingly, the variable voltage V_{DAC} may be increased or decreased to avoid the condition that the variable voltage V_{DAC} can not be adjusted, but the present disclosure is not limited thereto; that is, in the reset stage the variable voltage V_{DAC} may be reset to any value within the adjustable range R_{DAC}, and preferable the variable voltage V_{DAC} is not reset to the limit value of the adjustable range R_{DAC}. In this embodiment, the reset voltage V_{RST} is preferable equal to the reference voltage V_{REF}.

In addition, in FIGS. 3 and 5, the first sensing electrodes and the second sensing electrodes not being scanned by the control unit 30 (i.e. the associated input switch sets 11 and the output switch sets 13 are not turned on) are coupled to the reset voltage V_{RST}.

In each embodiment of the present disclosure, the input voltage source, the reset voltage, the reference voltage and the variable voltage may be positive voltages or negative voltages.

As mentioned above, in the conventional capacitive touch control system, the coupling charge variation caused by a touch event is compensated by using a plurality of different capacitors in a capacitor bank in order to detect a contact extent. However, forming a plurality of capacitors on a substrate can occupy a large area of the substrate. Therefore, the present disclosure further provides a touch system (FIGS. 3, 4 and 5) that may provide a variable voltage to balance the coupling charge variation caused by a touch event such that a large amount of capacitors need not be formed in order to balance the coupling charge. The manufacturing cost is also decreased at the same time.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A capacitive touch control system, comprising:
a plurality of first sensing electrodes extending along a first direction in parallel;
a plurality of second sensing electrodes extending along a second direction in parallel;
a comparator comprising a positive input terminal and a negative input terminal; and
a control unit configured to sequentially couple the first sensing electrodes to an input voltage source, to sequentially couple two of the second sensing electrodes to the positive input terminal and the negative input terminal of the comparator respectively, to provide a first variable voltage to the positive input terminal and to provide a second variable voltage to the negative input terminal thereby balancing the positive input terminal and the negative input terminal.

2. The capacitive touch control system as claimed in claim 1, further comprising a plurality of input switch sets and a plurality of output switch sets, wherein the input switch sets are respectively coupled between the first sensing electrodes and the control unit, and the output switch sets are respectively coupled between the second sensing electrodes and the comparator.

3. The capacitive touch control system as claimed in claim 1, wherein the control unit is further configured to couple the first sensing electrodes and the second sensing electrodes to a reset voltage in a reset stage, and the reset voltage is not equal to the input voltage source.

4. The capacitive touch control system as claimed in claim 3, wherein the first variable voltage has a first adjustable range and the second variable voltage has a second adjustable range, and the first variable voltage is reset to a minimum voltage of the first adjustable range and the second variable voltage is reset to a maximum voltage of the second adjustable range in the reset stage.

5. The capacitive touch control system as claimed in claim 1, wherein the control unit adjusts at least one of the first variable voltage and the second variable voltage till a logic level of an output terminal of the comparator is changed.

6. The capacitive touch control system as claimed in claim 1, further comprising a first switch set and a first capacitor cascaded in series and a second switch set and a second capacitor cascaded in series, wherein the first switch set and the first capacitor are coupled between the first variable voltage and the positive input terminal, and the second switch set and the second capacitor are coupled between second variable voltage and the negative input terminal.

7. A capacitive touch control system, comprising:
a plurality of first sensing electrodes extending along a first direction in parallel;
a plurality of second sensing electrodes extending along a second direction in parallel;
a comparator comprising a first input terminal and a second input terminal, wherein the second input terminal is coupled to a reference voltage; and
a control unit configured to sequentially couple two of the first sensing electrodes to a first input voltage source and a second input voltage source respectively, to sequentially couple the second sensing electrodes to the first input terminal of the comparator and to provide a variable voltage to the first input terminal of the comparator thereby balancing the first input terminal and the reference voltage.

8. The capacitive touch control system as claimed in claim 7, further comprising a plurality of input switch sets and a plurality of output switch sets, wherein the input switch sets are respectively coupled between the first sensing electrodes and the control unit, and the output switch sets are respectively coupled between the second sensing electrodes and the first input terminal of the comparator.

9. The capacitive touch control system as claimed in claim 7, wherein the control unit is further configured to couple the first sensing electrodes and the second sensing electrodes to a reset voltage in a reset stage.

10. The capacitive touch control system as claimed in claim 9, wherein the reset voltage is between a voltage value of the first input voltage source and a voltage value of the second input voltage source.

11. The capacitive touch control system as claimed in claim 7, wherein the control unit adjusts the variable voltage till a logic level of an output terminal of the comparator is changed.

12. The capacitive touch control system as claimed in claim 7, further comprising a switch set and a capacitor cascaded in series, wherein the switch set and capacitor are coupled between the variable voltage and the first input terminal of the comparator.

13. The capacitive touch control system as claimed in claim 7, wherein the first input terminal is a positive input terminal and the second input terminal is a negative input terminal, or the first input terminal is a negative input terminal and the second input terminal is a positive input terminal.

14. A capacitive touch control system, comprising:
a plurality of first sensing electrodes extending along a first direction in parallel;
a plurality of second sensing electrodes extending along a second direction in parallel;
a comparator comprising a first input terminal and a second input terminal, wherein the second input terminal is coupled to a reference voltage; and
a control unit configured to sequentially couple the second sensing electrodes to the first input terminal of the comparator and to couple two of the first sensing electrodes to an input voltage source and a variable voltage respectively thereby balancing the first input terminal and the reference voltage.

15. The capacitive touch control system as claimed in claim 14, further comprising a plurality of input switch sets and a plurality of output switch sets, wherein the input switch sets are respectively coupled between the first sensing electrodes and the control unit, and the output switch sets are respectively coupled between the second sensing electrodes and the first input terminal of the comparator.

16. The capacitive touch control system as claimed in claim 14, wherein the control unit is further configured to couple the first sensing electrodes and the second sensing electrodes to a reset voltage in a reset stage.

17. The capacitive touch control system as claimed in claim 16, wherein the reset voltage is between a voltage value of the input voltage source and a voltage value of the variable voltage.

18. The capacitive touch control system as claimed in claim 14, wherein the control unit adjusts the variable voltage till a logic level of an output terminal of the comparator is changed.

19. The capacitive touch control system as claimed in claim 14, wherein the two first sensing electrodes, which are respectively coupled to the input voltage source and the variable voltage, are adjacent to each other.

20. The capacitive touch control system as claimed in claim 14, wherein the first input terminal is a positive input terminal and the second input terminal is a negative input terminal, or the first input terminal is a negative input terminal and the second input terminal is a positive input terminal.
